(19) United States
(12) Patent Application Publication
(10) Pub. No.: US 2020/0122531 A1
(43) Pub. Date: Apr. 23, 2020

(54) Small automatic tire changing machine

(71) Applicant: Liping yao, Wenzhou City (CN)

(72) Inventor: Liping yao, Wenzhou City (CN)

(21) Appl. No.: 16/724,386

(22) Filed: Dec. 23, 2019

(30) Foreign Application Priority Data
Oct. 11, 2019 (CN) 2019109643926

(51) Int. Cl. B60C 25/05; B66F 3/26

(52) U.S. Cl. CPC B60C 25/0515; B66F 2700/057; B66F 3/26

(57) ABSTRACT

The invention discloses a small automatic tire changing machine, which comprises an upper casing, wherein an installation cavity is provided in the upper casing, and a detachable sleeve disc oil tank is arranged in the installation cavity. There are bumps on the wall. The invention has simple structure, convenient maintenance, and convenient use. The device can be used in emergency situations, and it can automatically disassemble and assemble the tires of the vehicle, which greatly simplifies the tire change process and improves the vehicle. In addition to the disadvantages of laborious disassembly and removal of hub screws compared with traditional tire replacement tools, the device does not require laborious disassembly of the hub screws, so that female users can easily change tires by themselves. The device is small in size, stable and safe in work. Can be put in the car to go with the car for emergency needs.

### CROSS-REFERENCES TO RELATED APPLICATIONS

The present application claims priority from Chinese application No. 2019109643926 filed on Oct. 11, 2019 which is hereby incorporated by reference in its entirety.

### TECHNICAL FIELD

The invention relates to the field of vehicle maintenance, in particular to a small automatic tire changing machine.

### BACKGROUND OF THE INVENTION

Existing car tires are often punctured by such sharp objects after driving through sharp objects such as nail heads, glass bumps, etc., which can cause tires to leak air, flat tires, etc. If you continue to use damaged tires, extremely It is easy to cause danger and cause major traffic accidents. Therefore, it is necessary to replace damaged tires in time. However, the emergency tire replacement device provided on traditional cars is inconvenient to use and has a low degree of automation. It takes physical strength to replace the damaged tire, and the entire replacement takes a long time, and most female personnel cannot use it smoothly. Therefore, a small tire replacement device that can quickly disassemble the tire needs to be developed to replace the existing vehicle tire replacement device. In order to improve the tire changing efficiency in emergency situations.

### BRIEF SUMMARY OF THE INVENTION

Technical problem: The emergency tire replacement device provided on traditional cars is inconvenient to use and has a low degree of automation. Users need to spend a lot of physical energy to replace damaged tires, and the entire replacement takes a long time. Most female personnel Cannot be used smoothly.

In order to solve the above problem, a small automatic tire changing machine is designed in this example. The small automatic tire changing machine in this example includes an upper case, and the upper case is provided with a mounting cavity, and the mounting cavity is provided with Detachable sleeve disc oil tank, the sleeve disc oil tank is provided with bumps on the upper and lower wall surfaces, and the mounting cavity is provided with grooves on the upper and lower inner walls, so that the sleeve disc oil tank can pass through the inner wall of the installation cavity. Friction connection. The upper and lower walls of the mounting cavity are symmetrically and threadedly provided with fixing screws. The fixing screws can fix the sleeve disc oil tank in the mounting cavity. The left wall of the mounting cavity is provided with A power cavity, in which a control device is provided, which can provide power for the device. A rotatable longitudinal connecting shaft is provided in the upper wall of the power cavity, and the top of the longitudinal connecting shaft extends into the installation. In the cavity, a first transmission gear is fixed at the top of the longitudinal connecting shaft, five sleeve shafts are arranged in an annular array in the left wall of the sleeve disc oil tank, and a second is fixed at the left end of the sleeve shaft at the top. Transmission gear, the first transmission gear and The second transmission gear is connected by meshing, so that the power of the control device can be transmitted to the sleeve shaft through the first transmission gear and the second transmission gear, and the lower end of the upper casing is provided with a base. The upper end of the base is provided with a sliding cavity. The left and right walls of the sliding cavity are symmetrically provided with tooth surfaces. The lower end of the upper housing is provided with a gear cavity symmetrically. The sliding gear mechanism is provided in the gear cavity. The sliding gear mechanism is provided with a rotatable sliding gear, and the upper casing is meshed with the base through the sliding gear. When the sliding gear rotates, the upper casing can be driven to slide up and down. A connecting plate is provided at the left end of the base, and a rotatable roller is symmetrically arranged in the lower wall of the connecting plate. A small roller is fixed on the roller, and the connecting plate can pass through the small roller. Sliding left and right around the base, a car lifting device is fixed at the left end of the connecting plate, and the car lifting device can lift the car to facilitate the tire replacement.

Beneficially, the sleeve disc oil tank can be replaced according to the hub screw model of different models. The sleeve disc fuel tank is provided with five sleeve shafts in a circular array on the right end of the sleeve shaft. A sleeve is fixedly installed, and the right end of the sleeve can be sleeved on the screw of the automobile wheel hub. When the sleeve shaft drives the sleeve to rotate, the sleeve can remove the screw on the automobile wheel hub. A chain gear is fixed on the sleeve shaft, the chain gear is located between the second transmission gear and the sleeve, and a chain is provided in meshing connection between the chain gears, so as to be the topmost chain When the gear rotates, it can drive the remaining chain gears to rotate synchronously through the chain.

Wherein, the control device includes a motor fixedly mounted on the left wall of the power cavity, a main power shaft is connected to the right end of the motor, and a sleeve shaft is sleeved on the main power shaft. The spline meshes with the main power shaft. A magnetic block is slidingly connected to the left end of the sleeve shaft, a spring is elastically connected to the left end of the magnetic block, and an electromagnet is elastically connected to the left end of the spring. Iron is fixed between the upper and lower walls of the power cavity, a central gear is fixed at the right end of the sleeve shaft, and a rotatable first positioning shaft is provided in the left wall of the power cavity, and the right end of the first positioning shaft is fixed. A left gear is provided, and a rotatable second positioning shaft is provided in the right wall of the power chamber. A right gear is fixedly located at the left end of the second positioning shaft. The central gear can be connected with the left gear or the right gear. Mesh connection.

Advantageously, a third transmission gear is fixed on the second positioning shaft, the third transmission gear is located on the right end of the right gear, and an upper end of the third transmission gear is meshed with a fourth transmission gear. The four transmission gear shafts are fixedly provided with the longitudinal connection shaft, and the upper end of the longitudinal connection shaft is fixedly connected with the first transmission gear.

Advantageously, a first pulley is fixed on the first positioning shaft, the first pulley is located at the left end of the left gear, a belt is connected to the first pulley, and a lower wall of the power chamber is provided with a A rotating central connecting shaft has a second pulley inherent in the central connecting shaft, the second pulley is connected to the lower end of the belt, and left and right ends of the central connecting shaft extend into the gear cavity.

Wherein, the sliding gear mechanism includes a third positioning shaft rotatably provided in the gear cavity, a first bevel gear is fixed on the third positioning shaft, and the first bevel gear is close to the second A second bevel gear is meshed and connected at one end of the pulley, the second bevel gear is fixed to the left and right ends of the central connecting shaft, the sliding gear is fixed to the third positioning shaft, and the sliding gear is located at The rear end of the first bevel gear is described.

The automobile lifting device includes a piston cylinder fixedly located at the left end of the connecting plate, a piston rod that can be slid up and down is arranged in the piston cylinder, a buffer block is fixed at the top of the piston rod, and a bottom end of the piston cylinder There are three pulleys in the horizontal array, which can drive the piston cylinder to slide on the ground. The right end of the piston cylinder is connected with a down pipe. The down pipe is provided with a down pipe valve. The down pipe valve can control the valve. Said opening and closing of the lower pipe, an oil pump is connected to the right end of the lower pipe, an oil suction pipe is connected to the right end of the oil pump, a sleeve disc oil tank is connected to the right end of the suction pipe, and the sleeve disc oil tank stores hydraulic pressure. Oil, an upper pipe is connected to the upper end of the sleeve pan oil tank, and an upper pipe valve is arranged in the upper pipe, the upper pipe valve can control the opening and closing of the upper pipe, and the left end of the upper pipe and the piston The barrel is connected and the upper pipe is located at the upper end of the lower pipe.

The beneficial effects of the invention are: the structure of the invention is simple, the maintenance is convenient, and the use is convenient. The device can be used in emergency situations, and it can automatically disassemble and assemble the tires of the vehicle, which greatly simplifies the tire replacement process and improves the vehicle. In addition to the disadvantages of laborious disassembly and removal of hub screws compared with traditional tire replacement tools, the device does not require laborious disassembly of the hub screws, so that female users can easily change tires by themselves. The device is small in size, stable and safe in work. Can be put in the car to go with the car for emergency needs.

### BRIEF DESCRIPTION OF THE DRAWINGS

For ease of description, the present invention is described in detail by the following specific embodiments and the accompanying drawings.

FIG. 1 is a schematic diagram of the overall structure of a small automatic tire changing machine according to the present invention;

FIG. 2 is an enlarged schematic view of the “A-A” structure of FIG. 1; FIG.

FIG. 3 is an enlarged schematic view of the “B” structure of FIG. 1;

FIG. 4 is an enlarged schematic view of the “C” structure of FIG. 1;

FIG. 5 is an enlarged schematic view of the “D” structure of FIG. 1.

### DETAILED DESCRIPTION OF THE INVENTION

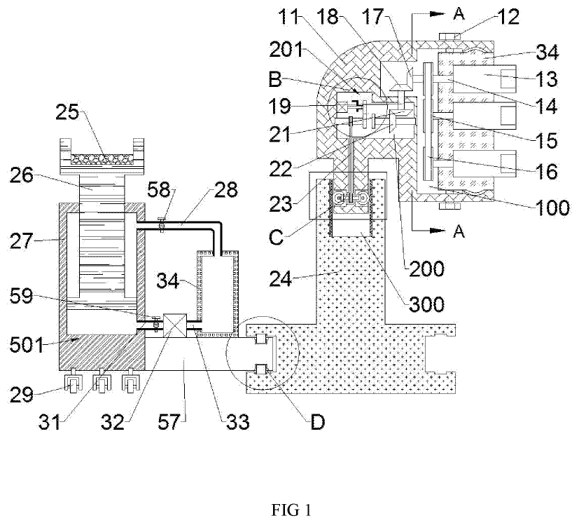

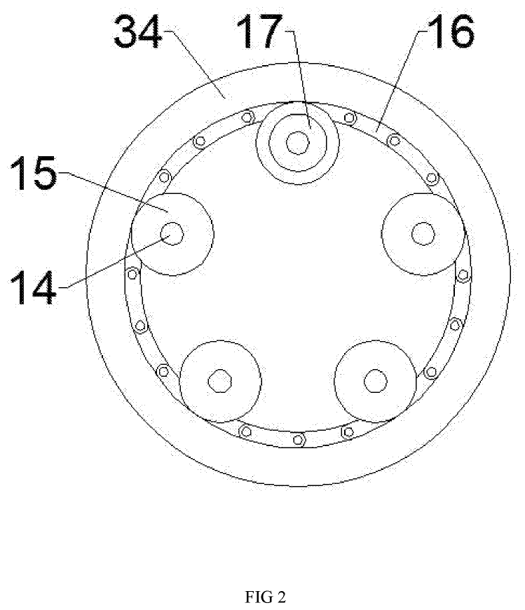

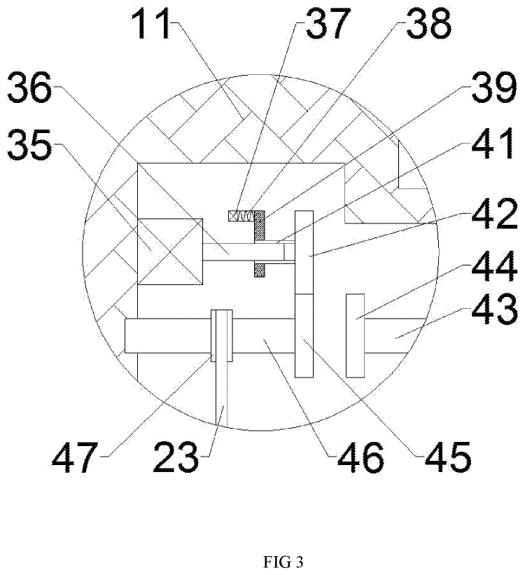

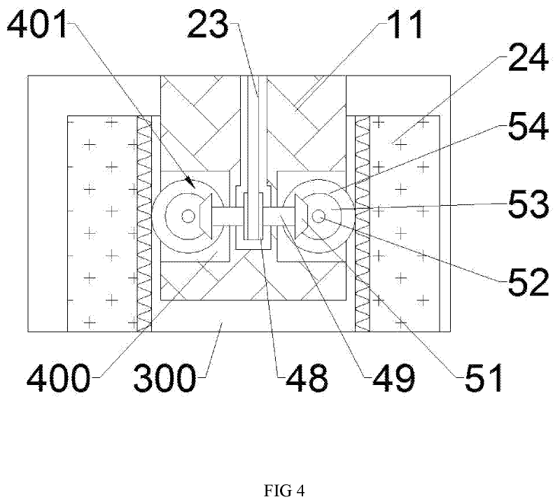

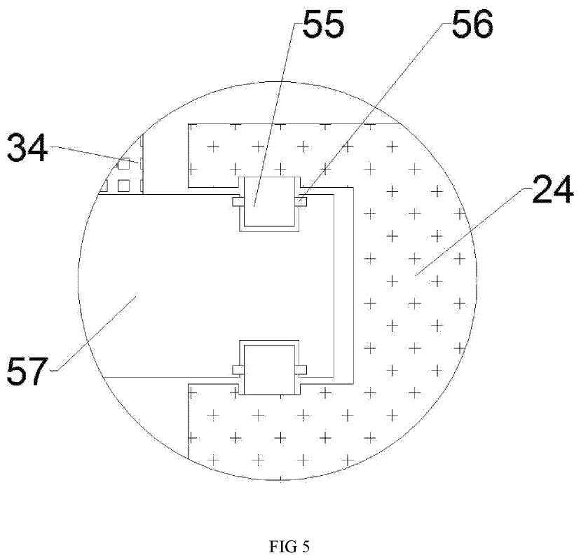

The present invention is described in detail below with reference to FIGS. 1-5. For convenience of description, the orientation described below is defined as follows: the up-down, left-right, front-back direction described below is consistent with the up-down, left-right, front-back direction of the projection relationship of FIG.

The invention relates to a small automatic tire changing machine, which is mainly used for vehicle tire changing maintenance. The invention will be further described below with reference to the accompanying drawings of the invention:

The small automatic tire changing machine according to the present invention includes an upper casing 11 which is provided with a mounting cavity 100 therein. The mounting cavity 100 is provided with a detachable sleeve disc oil tank 34. The sleeve disc oil tank 34 is provided with bumps on the upper and lower walls, and the mounting cavity 100 is provided with grooves on the upper and lower inner walls, and the sleeve disc oil tank 34 can be frictionally connected with the inner wall of the mounting cavity 100. The mounting cavity 100 is provided with fixing screws 12 symmetrically and threaded in the upper and lower walls. The fixing screws 12 can fix the sleeve disc oil tank 34 in the mounting cavity 100. The left wall of the mounting cavity 100 is provided in the mounting cavity 100. There is a power cavity 200. A control device 201 is provided in the power cavity 200, and the control device 201 can provide power to the device. A rotatable longitudinal connection shaft 19 is provided in the upper wall of the power cavity 200, and the longitudinal connection A top end of the shaft 19 extends into the mounting cavity 100, a first transmission gear 18 is fixed at the top end of the longitudinal connection shaft 19, and five sleeve shafts 14 are arranged in an annular array in the left wall of the sleeve disc oil tank 34, which are located at A second transmission gear 17 is fixed on the left end of the sleeve shaft 14 at the top. The gear 18 is meshed with the second transmission gear 17, and the power of the control device 201 can be transmitted to the sleeve shaft 14 through the first transmission gear 18 and the second transmission gear 17. The lower end of the upper casing 11 is provided with a base 24, and the upper end of the base 24 is provided with a sliding cavity 300. The left and right walls of the sliding cavity 300 are symmetrically provided with tooth surfaces. The lower end of the upper casing 11 is symmetrically provided with left and right sides. A gear cavity 400, which is provided with a sliding gear mechanism 401, and the sliding gear mechanism 401 is provided with a rotatable sliding gear 54, and the upper casing 11 is connected to the base through the sliding gear 54 The seat 24 is meshed and connected, and when the sliding gear 54 rotates, the upper housing 11 can be driven to slide up and down. A connecting plate 57 is provided at the left end of the base 24, and the connecting plate 57 is symmetrically arranged in the upper and lower walls. A rotatable roller 56, a small roller 55 is fixed on the roller 56, and the connecting plate 57 can slide around the base 24 left and right through the small roller 55, and the left end of the connecting plate 57 is fixed There is a car lifting device 501, which can lift the car and further It will replace the tire.

Beneficially, the sleeve disk oil tank 34 can be replaced according to the hub screw model of different models. The sleeve disk oil tank 34 is provided with five sleeve shafts 14 in an annular array, and the sleeve at the top is provided. A sleeve 13 is fixed on the right end of the barrel shaft 14, and the right end of the sleeve 13 can be sleeved on a car hub screw. When the sleeve shaft 14 drives the sleeve 13 to rotate, the sleeve 13 can turn the sleeve 13. Remove the screws on the wheel hub of the car. A chain gear 15 is fixed on the sleeve shaft 14. The chain gear 15 is located between the second transmission gear 17 and the sleeve 13. The intermeshing connection is provided with a chain 16, and when the topmost chain gear 15 rotates, it can drive the remaining chain gears 15 to rotate synchronously through the chain 16.

According to an embodiment, the control device 201 is described in detail below. The control device 201 includes a motor 35 fixed on the left wall of the power chamber 200, and a main power shaft 36 is connected to the right end of the motor 35. A sleeve shaft 41 is sleeved on the main power shaft 36. The sleeve shaft 41 meshes with the main power shaft 36 by a spline. A magnetic block 39 is slidably connected to the left end of the sleeve shaft 41. A spring 38 is elastically connected to the left end of the magnetic block 39, and an electromagnet 37 is elastically connected to the left end of the spring 38. The electromagnet 37 is fixed between the upper and lower walls of the power chamber 200, and the right end of the sleeve shaft 41 A central gear 42 is fixedly installed, and a rotatable first positioning shaft 46 is provided in the left wall of the power chamber 200. A left gear 45 is fixedly located at the right end of the first positioning shaft 46, and a right wall of the power chamber 200 is provided. A rotatable second positioning shaft 43 is provided with a right gear 44 fixed at the left end, and the central gear 42 can be meshed with the left gear 45 or the right gear 44.

Beneficially, a third transmission gear 22 is fixed on the second positioning shaft 43, the third transmission gear 22 is located at the right end of the right gear 44, and a fourth transmission is engaged with the upper end of the third transmission gear 22. The gear 21 and the fourth transmission gear 21 are fixedly provided with the longitudinal connection shaft 19 at an axial center, and an upper end of the longitudinal connection shaft 19 is fixedly connected with the first transmission gear 18.

Beneficially, a first pulley 47 is fixed on the first positioning shaft 46, the first pulley 47 is located at the left end of the left gear 45, a belt 23 is connected to the first pulley 47, and the power chamber The lower wall of 200 is provided with a rotatable central connecting shaft 49. A second pulley 48 is inherent on the central connecting shaft 49. The second pulley 48 is connected to the lower end of the belt 23. The left and right ends of the central connecting shaft 49 Extending into the gear cavity 400.

According to an embodiment, the sliding gear mechanism 401 is described in detail below. The sliding gear mechanism 401 includes a third positioning shaft 52 rotatably disposed in the gear cavity 400, and the third positioning shaft 52 is fixed on the third positioning shaft 52. A first bevel gear 53 is provided, and a second bevel gear 51 is meshed with one end of the first bevel gear 53 near the second pulley 48. The second bevel gear 51 is fixed to the left and right of the central connecting shaft 49. At both ends, the third positioning shaft 52 is fixed with the sliding gear 54, and the sliding gear 54 is located at the rear end of the first bevel gear 53.

According to the embodiment, the automobile lifting device 501 will be described in detail below. The automobile lifting device 501 includes a piston cylinder 27 fixed to the left end of the connecting plate 57. The piston cylinder 27 is provided with a slide up and down. A piston block 26, a buffer block 25 is fixed at the top end of the piston rod 26, and three pulleys 29 are arranged in a lateral array at the bottom end of the piston cylinder 27, so that the piston cylinder 27 can be driven to slide on the ground, and the piston A lower pipe 31 is connected to the right end of the barrel 27, and a lower pipe valve 59 is arranged in the lower pipe 31. The lower pipe valve 59 can control the opening and closing of the lower pipe 31. An oil pump is connected to the right end of the lower pipe 31 32. An oil suction pipe 33 is connected to the right end of the oil pump 32, and a sleeve disc oil tank 34 is connected to the right end of the oil suction pipe 33. The sleeve disc oil tank 34 stores hydraulic oil, and the upper end of the sleeve disc oil tank 34 An upper pipe 28 is connected to the upper pipe 28. An upper pipe valve 58 is provided in the upper pipe 28. The upper pipe valve 58 can control the opening and closing of the upper pipe 28. The left end of the upper pipe 28 communicates with the piston barrel 27. The upper pipe 28 is located at an upper end of the lower pipe 31.

The following is a detailed description of the use of a small automatic tire changer in this article in conjunction with FIGS. 1 to 5. In the initial state, the motor 35 and the oil pump 32 are not running, the entire device has no power source, and the piston rod 26 is retracted into the piston barrel In 27, the upper casing 11 is retracted in the sliding cavity 300, the electromagnet 37 is de-energized, and the central gear 42 is located between the left gear 45 and the right gear 44 and does not mesh with the left gear 45 and the right gear 44. Turn the connecting plate 57 so that the buffer block 25 is located below the chassis of the automobile. At this time, the oil pump 32 is started, and the lower pipe valve 59 and the upper pipe valve 58 are opened. The oil pump 32 passes the hydraulic oil in the sleeve pan oil tank 34 through the suction pipe 33 and the lower pipe. 31 is pumped into the piston cylinder 27, pushing the piston rod 26 to rise, so that the car can be lifted on one side. When the vehicle rises to the specified height, the oil pump 32 is closed, the lower pipeline valve 59 and the upper pipeline valve 58 are closed, so that the piston rod 26 Keep it in the designated position, then start the motor 35, the motor 35 drives the main power shaft 36 to rotate, the main power shaft 36 drives the sleeve shaft 41 to rotate, the sleeve shaft 41 drives the central gear 42 to rotate, at this time, the electromagnet 37 is energized, and the electromagnet 37 generate magnetism The magnetic block 39 slides the magnetic block 39 to the left, so that the magnetic block 39 drives the sleeve shaft 41 to slide to the left, and the sleeve shaft 41 drives the central gear 42 to slide to the left, so that the central gear 42 and the left gear 45 mesh with each other, and The central gear 42 drives the left gear 45 to start rotating. The left gear 45 drives the first positioning shaft 46. The first positioning shaft 46 drives the central connecting shaft 49 through the first pulley 47, the belt 23, and the second pulley 48. The central connecting shaft 49 The third bevel gear 51 and the first bevel gear 53 drive the third positioning shaft 52 to rotate, and the third positioning shaft 52 drives the sliding gear 54 to rotate. When the sliding gear 54 rotates, the upper housing 11 is further caused to slide upward, so that the automobile wheel hub The screw can be sleeved by the sleeve 13. At this time, the fixing screw 12 is tightened, the sleeve pan oil tank 34 is fixed, and then the electromagnet 37 is reversely energized, so that the electromagnet 37 generates a magnetic repulsion magnetic block 39, so that the magnetic block 39 goes to the right. The sliding causes the magnetic block 39 to drive the sleeve shaft 41 to the right, and the sleeve shaft 41 drives the central gear 42 to slide to the right, so that the central gear 42 is meshed with the right gear 44 and the central gear 42 drives the right gear 44 to open. The first gear 44 drives the second positioning shaft 43 to rotate, and the second positioning shaft 43 drives the vertical connecting shaft 19 to rotate through the third driving gear 22 and the fourth driving gear 21, and the vertical connecting shaft 19 passes the first driving gear 18 and the first The two transmission gears 17 drive the top sleeve shaft 14 to rotate, and the sleeve shaft 14 drives the top chain gear 15 to rotate. When the top chain gear 15 rotates, it drives the remaining chain gears 15 through the chain 16 to rotate synchronously, thereby making The sleeve 13 starts to rotate, and then the hub screws can be loosened. When the spare tire is replaced, the motor 35 is reversed, so that the sleeve 13 can re-tighten the hub screws, and then turn off the motor 35 and open the upper pipe valve 58 and The pipe valve 59 is lowered, so that the piston rod 26 starts to fall under the gravity of the car, and then the device is lifted out of the car, and the tire change is completed.

The beneficial effects of the invention are: the structure of the invention is simple, the maintenance is convenient, and the use is convenient. The device can be used in emergency situations, and it can automatically disassemble and assemble the tires of the vehicle, which greatly simplifies the tire replacement process and improves the vehicle. In addition to the disadvantages of laborious disassembly and removal of hub screws compared with traditional tire replacement tools, the device does not require laborious disassembly of the hub screws, so that female users can easily change tires by themselves. The device is small in size, stable and safe in work. Can be put in the car to go with the car for emergency needs.

The above are only specific embodiments of the invention, but the scope of protection of the invention is not limited to this. Any changes or substitutions that are not thought through without creative work should be covered by the scope of protection of the invention. Therefore, the protection scope of the invention shall be subject to the protection scope defined by the claims.

1. A small automatic tire changing machine according to the present invention comprises an upper casing, wherein an installation cavity is provided in the upper casing, and a detachable sleeve disc oil tank is provided in the installation cavity, and the upper and lower wall surfaces of the sleeve disc oil tank are provided. A convex block is provided on the upper and lower grooves of the mounting cavity, and the sleeve disc oil tank can be frictionally connected with the inner wall of the mounting cavity. The upper and lower walls of the mounting cavity are symmetrical and threaded. There are fixing screws which can fix the sleeve disc oil tank in the installation cavity. A power cavity is provided in the left wall of the installation cavity, and a control device is provided in the power cavity. Can power the device;
a rotatable longitudinal connecting shaft is provided in the upper wall of the power chamber, and the top end of the longitudinal connecting shaft extends into the installation cavity. A first transmission gear is fixed at the top end of the longitudinal connecting shaft, and the sleeve disc oil tank is provided. The inner ring array of the left wall is provided with five sleeve shafts, and a second transmission gear is fixedly located at the left end of the sleeve shaft at the top end, and the first transmission gear and the second transmission gear are meshed and connected;
the lower end of the upper housing is provided with a base, and the upper end of the base is provided with a sliding cavity. The left and right walls of the sliding cavity are symmetrically provided with tooth surfaces. The lower end of the upper housing is symmetrically provided with a gear cavity. The gear cavity is provided with a sliding gear mechanism, and the sliding gear mechanism is provided with a rotatable sliding gear, and the upper casing is meshed with the base through the sliding gear;
a connecting plate is provided at the left end of the base, and a rotatable roller is symmetrically arranged in the lower wall of the connecting plate. A small roller is fixed on the roller, and the connecting plate can be wound by the small roller. The base slides left and right, and a car lifting device is fixed at the left end of the connecting plate. The car lifting device can lift the car to facilitate the tire replacement.

2. The small automatic tire changing machine according to claim 1, characterized in that the sleeve disc oil tank can be replaced according to the hub screw model of different models, and a ring array on the sleeve disc oil tank is provided with five Sleeve shafts, a sleeve is fixed at the right end of the sleeve shaft at the top, and the right end of the sleeve can be sleeved on a car hub screw, so that when the sleeve shaft drives the sleeve to rotate The sleeve can remove the screws on the automobile wheel hub. A chain gear is fixed on the sleeve shaft, and the chain gear is located between the second transmission gear and the sleeve. The chain gear A chain is provided for the intermeshing connection, so that when the topmost chain gear rotates, it can drive the remaining chain gears to rotate synchronously through the chain.

3. The small automatic tire changing machine according to claim 1, wherein the control device comprises a motor fixedly installed on the left wall of the power chamber, and a main power shaft is connected to the right end of the motor. A sleeve shaft is sleeved on the main power shaft, and the sleeve shaft is engaged with the main power shaft through a spline. A magnetic block is slidingly connected to the left end of the sleeve shaft, and a magnetic block is elastically connected to the left end of the sleeve. A spring, an electromagnet is elastically connected to the left end of the spring, the electromagnet is fixed between the upper and lower walls of the power chamber, a central gear is fixed at the right end of the sleeve shaft, and the left wall of the power chamber is provided inside There is a rotatable first positioning shaft, a left gear is fixed at the right end of the first positioning shaft, a rotatable second positioning shaft is located in the right wall of the power chamber, and a right is fixed at the left end of the second positioning shaft. A gear, the central gear can be meshed with the left gear or the right gear.

4. The small automatic tire changing machine according to claim 3, wherein a third transmission gear is fixed on the second positioning shaft, the third transmission gear is located at the right end of the right gear, and the first A fourth transmission gear is meshed with the upper end of the three transmission gears. The fourth transmission gear is fixedly provided with the longitudinal connection shaft at its center. The upper end of the longitudinal connection shaft is fixedly connected with the first transmission gear.

5. The small automatic tire changing machine according to claim 3, wherein a first pulley is fixed on the first positioning shaft, the first pulley is located at the left end of the left gear, and the first pulley A belt is connected to the upper side, and a rotatable central connecting shaft is provided in the lower wall of the power chamber. A second pulley is inherent on the central connecting shaft, and the second pulley is connected to the lower end of the belt. The central connecting shaft Left and right ends extend into the gear cavity.

6. The small automatic tire changing machine according to claim 5, wherein the sliding gear mechanism includes a third positioning shaft rotatably provided in the gear cavity, and the third positioning shaft is fixedly mounted on the third positioning shaft. There is a first bevel gear. A second bevel gear is meshed with one end of the first bevel gear near the second pulley. The second bevel gear is fixed at the left and right ends of the central connecting shaft. The third The sliding gear is fixed on the positioning shaft, and the sliding gear is located at the rear end of the first bevel gear.

7. The small automatic tire changing machine according to claim 1, wherein the automobile lifting device comprises a piston cylinder fixedly attached to the left end of the connecting plate, and a piston which can slide up and down is arranged in the piston cylinder. A buffer block is fixed at the top end of the piston rod, and three pulleys are arranged in a lateral array at the bottom end of the piston barrel, thereby driving the piston barrel to slide on the ground, and a lower pipe is connected to the right end of the piston barrel, The lower pipe is provided with a lower pipe valve, which can control the opening and closing of the lower pipe. An oil pump is connected to the right end of the lower pipe, and an oil suction pipe is connected to the right end of the oil pump. A sleeve disc oil tank is connected to the right end, and the sleeve disc oil tank stores hydraulic oil. An upper pipe is connected to the upper end of the sleeve disc oil tank, and an upper pipe valve is provided in the upper pipe. The opening and closing of the upper pipe can be controlled, the left end of the upper pipe is in communication with the piston barrel, and the upper pipe is located at the upper end of the lower pipe.
